(19) United States
(12) Patent Application Publication
(10) Pub. No.: US 2003/0088776 A1
(43) Pub. Date: May 8, 2003

(54) Method and apparatus for evidence generation

(76) Inventors: Along Lin, Bristol (GB); Yolanta Beres, Bristol (GB)

Correspondence Address: HEWLETT-PACKARD COMPANY, Intellectual Property Administration, P.O. Box 272400, Fort Collins, CO, 80527-2400, US

(21) Appl. No.: 10/263,443

(22) Filed: Oct. 2, 2002

(30) Foreign Application Priority Data
Oct. 3, 2001 (GB) 0123675.1

(51) Int. Cl. H04L 9/00

(52) U.S. Cl. 713/176; 713/180

(57) ABSTRACT

A generic evidence generation core (GEGC) 320 receives evidence data from an environment-specific security application 21 and performs one or more generic validating functions using available validating units, including a time stamper 323, a trusted signer 324 and a cryptographic unit 325, amongst others. Validation data is formed by the validating units, under the control of an evidence generation specification 314, which tailors the validating functions of the GEGC 320 according to the needs of particular evidence data. In use, the evidence generation specification 314 is selected in response to a particular evidence data supplied from the environment specific security application 21, and a policy evaluator 322 determines the functions of the GEGC 320 to be applied to that evidence data. The evidence generation specification 314 is ideally written in advance using an evidence generation specification unit 31 which combines an evidence template 311 with an evidence generation policy 312 using an authoring tool 313, with input from an authoring user 20. The generated evidence, combining the evidence data and the validation data, is stored in a secure evidence store 40. Hence, the evidence is created in a manner which is trustworthy and reliable, and the evidence generation system is applicable to a wide variety of specific environments.

### FIELD OF THE INVENTION

The present invention relates in general to a method and apparatus for the generation of reliable evidence, and relates in general to management, storage and retrieval of generated evidence.

### DESCRIPTION OF THE RELATED ART

In everyday life, evidence plays an important role that can either be very rigorous or quite informal, depending in the environment in which the evidence is used. Evidence can take many different forms, including written documents, faxes, photographs, video tapes, recorded audio messages, or, more recently, electronic data on a computing platform. The present invention is particularly concerned with electronic evidence data related to a computing platform, and it is desired to generate and store this evidence in a manner which is trustworthy and reliable.

A problem arises in that evidence may need to be stored for an extended period, such as many years. It is desired to verify that the retrieved evidence corresponds to the originally gathered evidence, and has not been altered or degraded in storage. As one example, it is desired to provide evidence for use in civil or criminal legal proceedings. An investigator needs access to a reliable and trustworthy method for capturing, storing, processing and investigating data from computers, using a methodology whereby evidence presented will be acceptable and valid. Professional investigators such as police and other law enforcement agencies, IT security staff and customs officials have already started to use electronic evidence from initial investigations through to the provision of expert witness statements. More recently, electronic evidence is considered to be useful in the field of dispute resolution, particularly in E-commerce and business to business transactions. Whilst both conventional and electronic markets rely on high levels of mutual trust, electronic transactions create specific challenges for both businesses and individuals. In particular, electronic transactions are impersonal and remote, and so exchange mechanisms are required that reduce or eliminate the risk that a party can misrepresent details of a transaction. Also, parties may strongly desire anonymity, but this increases the risk of fraud. Therefore, there is a strong need for evidence to be taken concerning an electronic transaction. As another example, in financial businesses such as investment, stock market or banking, evidence can mean both what has already occurred and what will occur in the future. As one level, a potential lender or investor evaluates a business or a borrower to determine a level of risk on repayment of the invested or loaned capital. To some extent, these financial decisions are based on data provided such as financial statements and projections. In a stock market environment, evidence can form any information such as customer commitments, opinions of security analysts, business and management experience, past success, informal market research, market trends, consumer appeal, retention of skilled employees, and availability of any special resources (e.g. a valuable patent).

Another problem arises in that evidence gathering is typically undertaken in a specialised manner according to each environment, giving rise to highly individual forms of evidence with little, or no, accepted standards as to quality, reliability or security. In each environment, a specialised application is developed to generate evidence, giving rise to unnecessary duplication of effort. Further, it is difficult to compare evidence generated from one environment with evidence generated from another environment.

### SUMMARY OF THE INVENTION

An aim of the present invention is to provide a method and apparatus for generation of evidence, preferably in a manner which is trusted and reliable. Another aim of the present invention is to provide a method and apparatus for generation of evidence, which is applicable to a wide variety of environments and allows evidence to be gathered from a wide variety of sources.

According to a first aspect of the present invention there is provided a method for generating evidence, comprising the steps of: forming an evidence generation specification in an evidence generation specification unit, by specifying one or more amongst a plurality of evidence validation functions; providing the evidence generation specification to a generic evidence generation unit; receiving evidence data from a specific environment; comparing the evidence data against the evidence generation specification; and selectively forming validation data associated with the evidence data, by performing one or more generic validation functions in the generic evidence generation unit, according to the evidence generation specification; combining the evidence data and the validation data to form an evidence; and storing the evidence.

Preferably, the evidence generation specification is formed by combining an evidence template with an evidence generation policy, the evidence template specifying objects, operations and identities of an evidence data, and the evidence generation policy specifying conditioned relationships between the objects, operations and identities and specifying validation function parameters, the evidence generation specification thereby specifying one or more of the generic validation functions to be performed in relation to the evidence data. Here, the evidence generation specification specifies the manner of performance of one or more generic validation functions to be performed associated with the evidence data. Also, the evidence generation specification specifies a manner of storing the evidence.

Preferably, the one or more generic validation functions include one or more functions selected from a time stamping function, a signing function, or a cryptographic function.

The method suitably comprises receiving evidence data from an environment specific security application at the generic evidence generation core, through an application program interface. Preferably, the evidence data is provided to the generic evidence generation core in a generic standard format. Preferably, the evidence data comprises objects, operations and identities provided to the generic evidence generation core arranged according to a pre-defined evidence template.

The method suitably comprises an authoring process including forming a plurality of evidence generation specifications, and selecting one amongst the available of plurality evidence generation specifications to be applied to the evidence data. Here, the authoring process preferably comprises forming an evidence generation specification by selecting one amongst a plurality of evidence templates, each evidence template specifying a standard set of objects, operations and identities.

Also according to the present invention there is provided a method for generating evidence, comprising the steps of: forming one or more evidence generation specifications in an evidence generation specification unit, each evidence generation specification comprising an evidence template that specifies identities, operations and objects, and an evidence policy that specifies relationships between the identities, operations and objects and specifies one or more validation functions; receiving evidence data into a generic evidence generation unit; selecting one of the one or more evidence generation specifications; evaluating the evidence policy of the selected evidence template and selectively performing one or more specified validation functions to form validation data; and combining the evidence data and the validation data in the generic evidence generation unit to form an evidence.

Preferably, the evidence policy of each evidence generation specification specifies a manner of storing an evidence, and the method comprises the step of storing the evidence according to the evidence policy of the selected evidence generation specification.

Preferably, the method comprises in a preliminary step, authoring a plurality of the evidence generation specifications, and passing the authored plurality of evidence generation specifications to the generic evidence generation unit.

Preferably, the evidence data includes identities, objects and operations, and the method comprises comparing a format of the evidence data against the evidence template of the selected evidence generation specification to confirm that the evidence data conforms to the evidence template.

Preferably, each evidence policy includes a set of generation parameters that define whether evidence is to be generated, and the method comprises testing the received evidence data against the generation parameters to determined whether, and in what form, the one or more validation functions are to be performed to obtain the validation data.

Preferably, each evidence generation specification is associated with at least one of a plurality of specific environments, and the method comprises receiving the evidence data from one of the plurality of specific environments.

According to a second aspect of the present invention there is provided an apparatus for generating evidence, comprising: a generic evidence generation core for receiving an evidence generation specification, and for receiving an evidence data; a policy evaluator arranged to evaluate the evidence data in relation to the evidence generation specification; a plurality of validation units each arranged to perform a generic validation function to form validation data, under control of the generic evidence generation core, such that an evidence is generated by combining the evidence data and the validation data; and an evidence store arranged to store the generated evidence.

Preferably, the apparatus further comprises an evidence generation specification unit having an authoring unit arranged to receive user commands and to produce an evidence generation specification by combining an evidence template with an evidence generation policy. Preferably, the authoring unit is arranged to produce a plurality of evidence generation specifications, each evidence generation specification comprising an evidence template that defines identities, objects and operations, and an evidence policy that specifies relationships between the identities, objects and operations of the evidence template and specifies generic validation functions to be applied to the evidence data. Preferably, the authoring unit is arranged to supply the plurality of evidence generation specifications to the generic evidence generation core.

According to a third aspect of the present invention there is provided an evidence generation system, comprising: an evidence generation specification unit that includes an authoring unit arranged to form a plurality of evidence generation specifications, each evidence generation specification including an evidence template that specifies identities, objects and operations of an evidence data, and an evidence policy that specifies validation functions to be applied to the evidence data; and a generic evidence generation unit for receiving evidence data and producing an evidence including the evidence data and validation data, wherein the generic evidence generation unit includes: a generic evidence generation core for receiving the plurality of evidence generation specifications and for receiving the evidence data; a policy evaluator arranged to evaluate the received evidence data in relation to the plurality of evidence generation specifications; and a plurality of validation units each arranged to perform a generic validation function under control of the generic evidence generation core according to a selected one of the evidence generation specifications, to provide the validation data; and an evidence store arranged to store the generated evidence.

Preferably, the generic evidence generation core is arranged to select one amongst the plurality of evidence generation specifications by comparing a format of the received evidence data against each evidence template, and the policy evaluator is arranged to evaluate the evidence data according to the selected one evidence generation specification.

In one example embodiment of the invention, the plurality of validation units include a trusted time stamper, a trusted signer, a cryptographic unit, a validation period setting unit, and a version unit.

Preferably, the generic evidence generation unit is arranged to receive the evidence data from an environment-specific security application through an application program interface.

Preferably, the generic evidence generation unit is arranged to receive the evidence data from an evidence requester apparatus that performs a transaction with a customer apparatus, and the evidence data represents identities, objects and operations of the transaction.

Preferably, the customer apparatus and the evidence requester apparatus each include a trusted platform module.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic overview of an example computing system employing evidence generation;

FIG. 2 is a schematic diagram of a preferred evidence generator apparatus;

FIG. 3 shows an example evidence;

FIG. 4 is a schematic flow diagram of a preferred evidence generation method; and

FIG. 5 is a schematic diagram of a preferred evidence support system.

### DETAILED DESCRIPTION OF THE INVENTION

The evidence generation system described herein is intended for use in a wide variety of specific applications. One example environment will be described in detail, and from this description it will be apparent that the invention can be adapted as required to suit other environments.

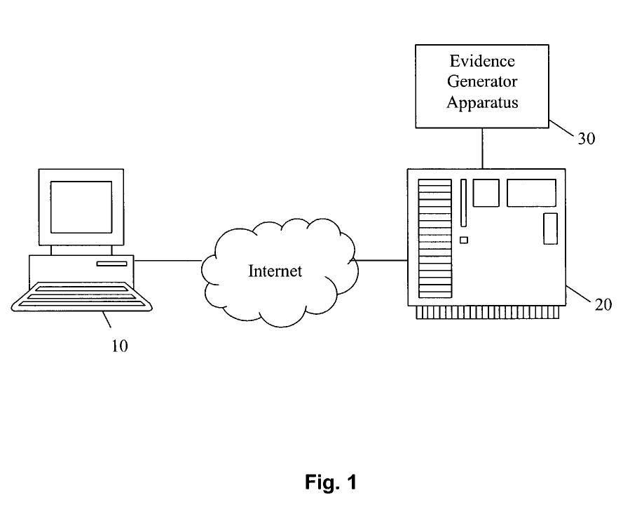

FIG. 1 shows an example system, wherein a transaction occurs between two transacting parties 10 and 20, and evidence is gathered and verified by an evidence generating apparatus 30. Here, one of the parties 20 acts as an evidence requester. As one example, the parties are a customer 10 and a banking institution 20, who co-operate to perform a banking transaction. The banking institution 20 desires to generate evidence of the transaction, in a manner which is reliable and trustworthy.

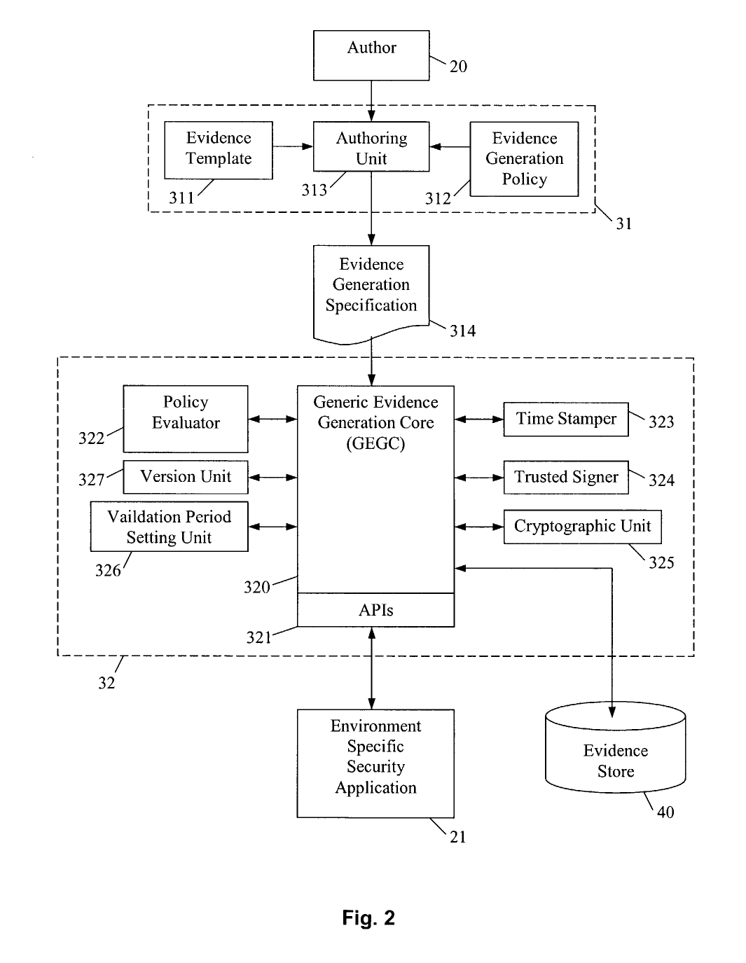

FIG. 2 shows the evidence generator apparatus 30 in more detail, comprising an evidence generation specification unit 31, a generic evidence generation unit 32, and an evidence store 40.

The generic evidence generation unit 32 comprises a generic evidence core (GEGC) 320, which is arranged to form verification data, according to a limited number of predetermined functions. The GEGC 320 comprises a plurality of evidence verifier units, which each provide verification of supplied evidence data. In this example, the GEGC co-operates with a trusted time stamper 323, a trusted signer 324, a cryptographic unit 325, a validation period setting unit 326, and a version unit 327, amongst others. The GEGC 320 is arranged to produce verification data that is associated with received evidence data, using the plurality of evidence verifier units 323-327, thereby producing evidence according to a predetermined evidence standard.

The evidence generation specification (EGS) unit 31 is arranged to produce an evidence generation specification 314, by combining an evidence template 311 with an evidence generation policy 312, under control of an authoring unit 313. The authoring unit 313 is conveniently represented as a graphical user interface (GUI) and is made available to an authorised author. In the present example, the author is associated with the evidence requester 20. The author specifies evidence parameters and features to complete one of many available evidence templates 311, and specifies relation of the parameters in the evidence generation policy 312. Conveniently, the template 311 specifies who and what will form the evidence, in terms of identities, operations and objects, whilst the policy 312 specifies when, where and how the evidence is to be generated. Here, a problem has been identified in that it is difficult to provide standard validation functions across many different specific environments. However, the use of evidence templates and an evidence policy allows an evidence generation specification to be authored for any specific environment, from a relatively small number of standard options. This authoring process is suitably performed during an establishment phase, prior to the gathering of evidence. Suitably, the or each EGS 314 is generated remote from the GEGC 320, such as at a remote server hosting the EGS unit 31, and is downloaded to the GEGC 320.

As shown in FIG. 2, a security application 21 of the requester 20 conveniently calls an API (application program interface) 321 of the GEGC 320, in order to pass evidence data to the GEGC. The GEGC selectively forms validation data associated with the evidence data, and stores the generated evidence in an evidence store 40. The evidence store 40 is suitably a secure and robust storage. Preferably, a distributed and duplicated storage is employed to minimise data loss in the event of a physical failure or adverse event such as subversion (hacking). Suitably, the EGS 314 specifies requirements of the storage 40, such as by selecting one amongst many available storage options.

In use, the GEGC 320 is coupled to receive evidence data from the requester 20, such as from the environment-specific security application 21, through the API 321. Here, the API is readily adapted to interface the GEGC with the environment specific security application 21. The evidence data is supplied in a predetermined format, preferably a generic standard format. In this example, the evidence data provides objects, operations and identities associated with the banking transaction. The GEGC forms validation data for the evidence data, following the specification of the EGS 314, under control of a policy evaluator 322. The policy evaluator 322 determines whether, and, if so, which validation functions should be applied to a particular evidence data, by comparing objects, operations and identities in the evidence data against an evidence policy in each EGS.

The environment-specific security application 21, through the API 321, allows selection of an appropriate EGS, and the policy evaluator 322 thereby determines the functions of the GEGC to be applied to each evidence data. Suitably, the security application 21 specifies the EGS to be applied to the evidence data. As one example, the validation data formed by the GEGC 320 includes an encryption envelope signed by the trusted signer 324, a time-stamp formed by the time stamper 323, a reference to a cryptographic algorithm used to encrypt the evidence data, as determined by the cryptographic unit 325, a version number provided by the version number unit 327, giving the version number of the evidence template adapted for this EGS, and a valid period set by the validation period setting unit 327, specifying a period in which the evidence will remain valid. Optionally, other verifications are formed by other verification units. Suitably, the verification data is formed selectively, according to the objects, operations and identities of each evidence data, as determined by the policy evaluator 322.

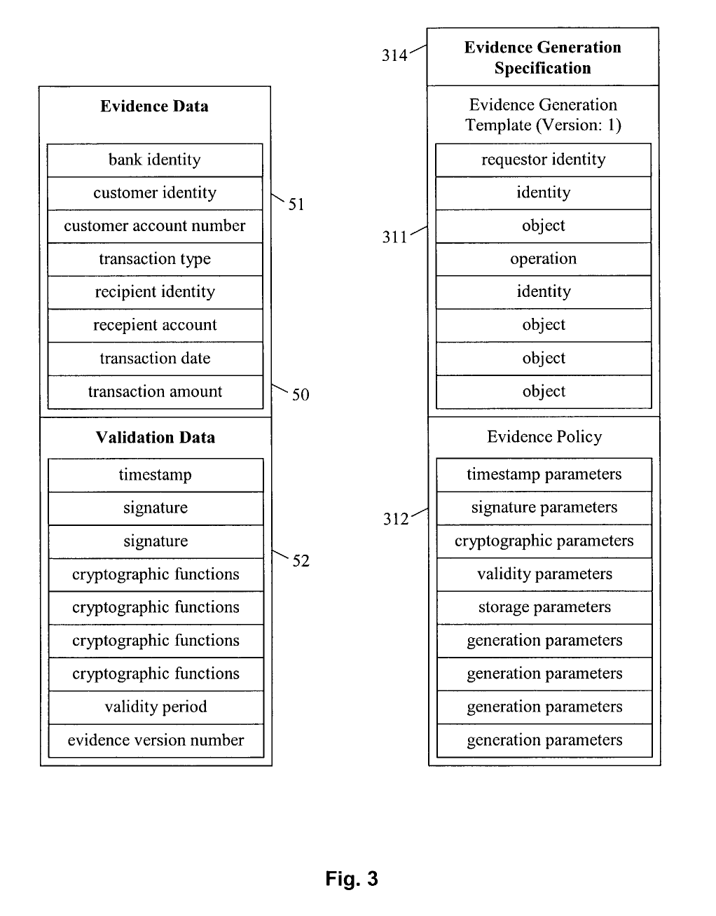

FIG. 3 shows an example evidence 50 formed by combining evidence data 51 received from an evidence requester 20 and validation data 52 formed by the GEGC 320. The evidence data shown in FIG. 3 illustrates an example environment of a banking transaction, and can be adapted as required to suit other environments. FIG. 3 also shows an example evidence generation specification 314 which is employed to generate the evidence 50.

The customer 10 and the banking institution 20 perform authentication to establish mutual trust, which can be achieved by any suitable mechanism. Typically, the customer presents a digital identification certificate as proof of the customer's identity, as part of that authentication process. The banking institution 20 then gathers the evidence data 51 which in this example includes an identity of the banking institution 20, an identity of the customer 10, details of the account or accounts involved, details of the transaction type (such as a transfer of funds between accounts), an identity of a fund transfer recipient, details of the recipient account, a transaction date and a transaction amount. Hence, the evidence data 51 provides objects, operations and identities associated with the banking transaction.

The evidence generation specification 314 comprises the evidence generation template 311 and the evidence generation policy 312. Here, the evidence generation template 311 specifies the format of the objects, operations and identities provided in the evidence data 51. In this example, an evidence generation template version number 1 is specified, and the evidence data 51 provided by the requester apparatus 20 should conform to this template. In the authoring process, the evidence generation template version most appropriate to the evidence data 51 is selected when forming the evidence generation specification 314. Hence, the evidence data 51 is received by the GEGC 320 in a standard and predictable format.

The second part of the evidence generation specification 314 is the evidence generation policy 312. The evidence policy 312 specifies the manner in which validation data is to be generated, by specifying control parameters of the validation unit of the GEGC 320. For example, the evidence policy 312 specifies the manner in which the time stamp is to be generated and specifies which time stamp operator should be used. Also, the evidence generation policy 312 specifies which signature should be used, and which cryptographic algorithm should be employed. Further, the evidence policy 312 specifies the validity period, e.g. that the evidence will remain valid for two years from the date of generation. Suitably, other validity parameters are specified, according to other available validity functions.

The evidence generation policy 312 further includes parameters specifying the manner in which the evidence 50 is to be stored, such as identifying the name of a secure database to be used for the storage.

As another option, the preferred evidence generation policy 312 further includes a set of generation parameters, which specify when the evidence is to be generated. This set of rules can be specified in any suitable format and represent conditions such as:

1. Evidence is generated if the transaction type is a “withdrawal” or “transfer” but not if the transaction type is a “balance enquiry”.

2. Evidence is only generated for a “withdrawal” or “transfer” type transaction if the amount is above a predetermined limit such as £1000 (or $1000).

3. Evidence is only generated for an “open new account” type transaction if the account balance when opened is below £100 (or $100), and the transaction time is between 6.00 pm and 6.00 am.

It is clear that the generation parameters can be specified according to the needs of each specific environment, referring to the objects, operations and identities found in the evidence data. Conveniently, the generation parameters are specified from amongst a limited standard set of available parameters, in the authoring process. In use, the generation parameters are readily tested, to determine whether evidence should be generated for this transaction.

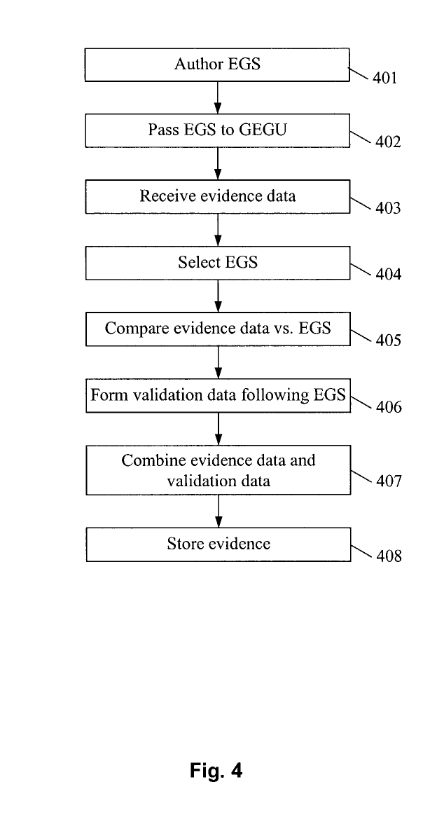

FIG. 4 is a schematic flow diagram illustrating the preferred evidence generation method. A set of evidence generation specifications (EGS) are authored in step 401, and passed to the generic evidence generation unit 320 in step 402. The GEGU 320 receives evidence data in step 403, and selects an appropriate evidence generation specification in step 404, either by recognising a format of the received evidence data, or by being informed of the appropriate EGS. Objects, operations and identities of the evidence data are optionally checked for conformity with the evidence template of the selected EGS, in step 405. Validation data is formed according to the EGS in step 406, by applying a set of validation functions. Here, the evidence policy of the EGS define what evidence functions are to be performed, and the manner of their performance. The evidence data and the validation data are combined at step 407, and the resulting evidence is stored at step 408. Ideally the manner of storing of the evidence is also controlled by storage parameters of the evidence policy of the EGS.

Referring again to FIG. 1, the parties 10 and 20 to the transaction each suitably form part of a trusted computing system. Here, a computing platform employed by each party comprises a trusted platform module (TPM).

In this example system, the customer apparatus 10 is conveniently a computing platform. In one example, the customer apparatus 10 is a relatively portable handheld device such as a cellular telephone, personal digital assistant, a laptop computer or a palmtop computer. In another example the customer apparatus 10 is a relatively non-portable device such as a desktop computer.

The requester apparatus 20, in this example under control of a banking institution, is conveniently a computing platform such as a relatively powerful server, which operates in close co-operation with the evidence generator apparatus 30.

The trusted platform module (TPM) allows enquiries to be made of the apparatus 10 and 20 with a high degree of trust. More detailed background information concerning a trusted platform module suitable for use in the preferred embodiments of the invention is available from the Trusting Computing Platform Alliance at www.trustedpc.org. See in particular “TCPA Main Specification”, version 1.0, dated Jan. 25, 2001.

In the presently preferred embodiments of the invention, the TPM comprises a trusted device. The trusted device is a hardware component such as an application specific integrated circuit (ASIC). Preferably, the trusted device is mounted within a tamper-resistant housing. The trusted device is coupled to other parts of the user apparatus and is suitably mounted on a motherboard of a main computing unit of the user apparatus.

The TPM preferably performs many functions. One function of the TPM is to form an integrity metric representing the status and condition of the computing platform, or at least the status and condition of selected parts of the computing platform. The integrity metric is made available to a challenging enquirer who can then confirm that the computing platform is in a trusted status and condition, by comparing the integrity metric against expected values. Such a computing platform is then trusted to operate in a reliable and expected manner. For example, a trusted computing platform is trusted not to be subject to subversion such as by a virus, or by an unauthorised access, or by replication or impersonation.

The evidence generator apparatus 30 may take any suitable form. As one example, the evidence generator apparatus 30 is a computing platform provided remote from the requester apparatus 20. However, in a preferred example, the evidence generator apparatus 30, or at least some parts thereof, in particular the GEGC 320, are provided local to the requester apparatus 20. Hence, in this preferred example, large-scale transfer of evidence data between the requester 20 and the GEGC 320 is avoided. In one particularly preferred embodiment, the GEGC 320 is provided within the TPM of the requester apparatus 20. The validation units 323 to 327 are optionally provided in the TPM of the requester apparatus 20, or in an associated portion of the requester apparatus. Alternatively, any one or more of the validation units is provided remote from the GEGC 320, such as being operated by a trusted third party who provides, for example, a trusted time stamping service of the validation unit 323.

The evidence storage unit 40 is ideally provided local to the GEGC 320. The evidence storage unit 40 is ideally a hardware device such as a random access storage comprising one or more storage media units such as magnetic disk units or optical disc units, or an equivalent solid state device, and is optionally associated with a secure device such as a smart card or other token.

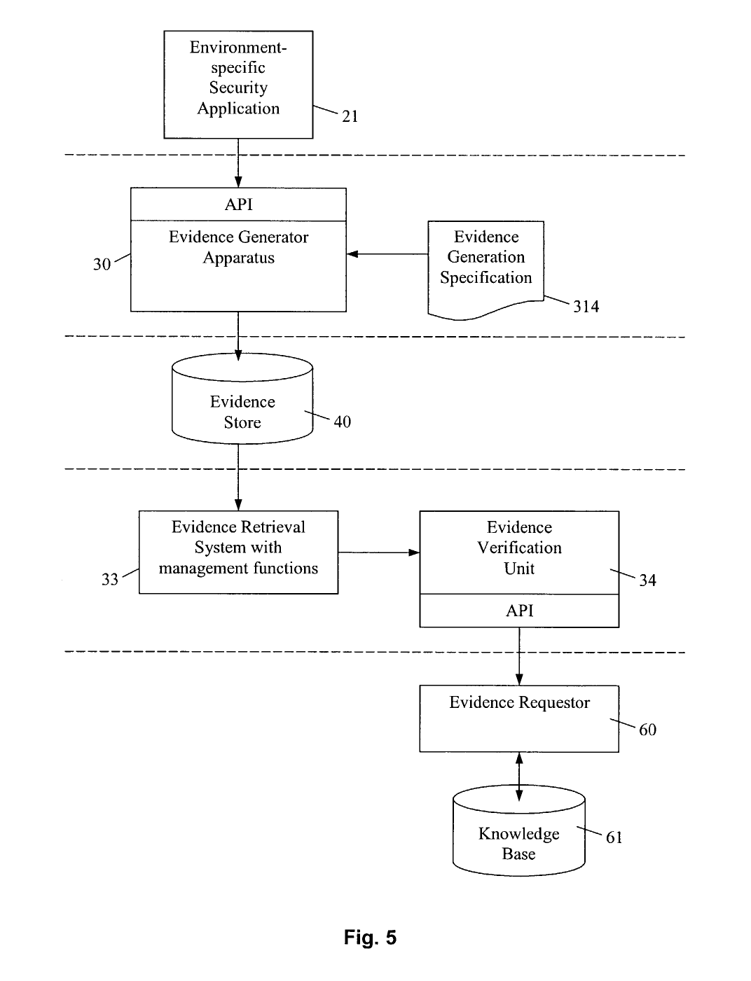

FIG. 5 shows an evidence support system (ESS) arranged to access and validate stored evidence, which has been generated as set out above. The ESS includes an evidence retrieval unit 33 coupled to the evidence storage 40, and an evidence verification unit (EVU) 34 arranged to verify retrieved evidences. The EVU 34 is suitably a generic unit, as a mirror of the GEGC 320. The EVU 34 includes an API for receiving verification requests, and for providing verification results to specialised enquirers 60. For example, the stored evidence is made available to a judicial support system, and is retrieved in co-operation with a case based reasoning (CBR) knowledge base 61 to trace and identify stored evidences relevant to a case of interest.

The preferred embodiment has been described with reference to the particular example of a banking transaction. However, it is clear that the described method and apparatus can be applied to many different environments. These include:

Secure web and e-mail servers—access to websites over the internet is normally monitored and audited to identify a potential mis-use. Also, most employees in organisations use e-mails extensively to communicate with the outside community, but sending or forwarding e-mails containing confidential or company proprietary information to unauthorised users is prohibited. Therefore, a security service is desired generating reliable and trustworthy evidence.

Electronic commerce—one of the most popular electronic commerce models is an electronic market place. Both buyers and sellers need a non-repudiation service, in case there is a dispute between them.

Electronic document management—applicable to e-government, ordering, purchasing, property agency, performance evaluation, ranking, salary review, mortgage arrangement, loan arrangement, contract exchange, and many other purposes. When an electronic document goes through each stage of a business process, a person responsible for that stage will read, write, modify or delete parts of the electronic document, based on that person's role. All of these changes to the business-critical document should be captured in a secure storage, and it is desired to generate reliable evidence for traceability and accountability purposes.

Secure operating systems—as one example, a Unix environment uses credentials, which commonly are user identities, determine a process privilege. To detect security breaches in a computer system, it is desired to trace how a user changes his or her privileges. Based on these low level details, it is possible to analyse the user's behaviour and detect a possible intrusion. Here again, it is desired to generate reliable and trustworthy evidence.

Public-key infrastructure (PKI)—a certifying authority (CA), as a fundamental part of a PKI, deals with issuing, revoking, suspending, and extending of digital certificates. It is desirable that these details should be logged in a secure database. The credentials provided by a user should be checked by a registration authority officer. Both the user's credentials and the registration authority officer should have available a digital signature, and it is desired to log this activity in a database for accountability purposes.

The method and apparatus described herein have many advantages. Evidence is generated in a manner which is reliable and trustworthy, under control of a generic evidence generation unit. Initialisation is made simple and convenient, through the use of a authoring unit to create an evidence generation specification, which is easily changed or updated for each specific environment of interest. The generated evidence can be stored for an extended period, such as many years, and the validation data allows verification that the retrieved evidence corresponds to the originally gathered evidence, and has not been altered or degraded in storage. Other features and advantages will be apparent from the description herein.

1. A method for generating evidence, comprising the steps of:
forming an evidence generation specification in an evidence generation specification unit, by specifying one or more amongst a plurality of evidence validation functions;
providing the evidence generation specification to a generic evidence generation unit;
receiving evidence data from a specific environment;
comparing the evidence data against the evidence generation specification; and
selectively forming validation data associated with the evidence data, by performing one or more generic validation functions in the generic evidence generation unit, according to the evidence generation specification;
combining the evidence data and the validation data to form an evidence; and
storing the evidence.

2. The method of claim 1, wherein the evidence generation specification is formed by combining an evidence template with an evidence generation policy, the evidence template specifying objects, operations and identities of an evidence data, and the evidence generation policy specifying conditioned relationships between the objects, operations and identities and specifying validation function parameters, the evidence generation specification thereby specifying one or more of the generic validation functions to be performed in relation to the evidence data.

3. The method of claim 2, wherein the evidence generation specification specifies the manner of performance of one or more generic validation functions to be performed associated with the evidence data.

4. The method of claim 1, wherein the evidence generation specification specifies a manner of storing the evidence.

5. The method of claim 1, wherein the one or more generic validation functions include one or more functions selected from a time stamping function, a signing function, or a cryptographic function.

6. The method of claim 1, comprising receiving evidence data from an environment specific security application at the generic evidence generation core, through an application program interface.

7. The method of claim 1, wherein the evidence data comprises objects, operations and identities arranged according to a pre-defined evidence template.

8. The method of claim 1, comprising forming a plurality of evidence generation specifications, and selecting one amongst the available of plurality evidence generation specifications to be applied to the evidence data.

9. The method of claim 2, comprising forming an evidence generation specification by selecting one amongst a plurality of evidence templates, each evidence template specifying a standard set of objects, operations and identities.

10. A method for generating evidence, comprising the steps of:
forming one or more evidence generation specifications in an evidence generation specification unit, each evidence generation specification comprising an evidence template that specifies identities, operations and objects, and an evidence policy that specifies relationships between the identities, operations and objects and specifies one or more validation functions;
receiving evidence data into a generic evidence generation unit;
selecting one of the one or more evidence generation specifications;
evaluating the evidence policy of the selected evidence template and selectively performing one or more specified validation functions to form validation data; and
combining the evidence data and the validation data in the generic evidence generation unit to form an evidence.

11. The method of claim 10 wherein the evidence policy of each evidence generation specification specifies a manner of storing an evidence, and the method comprises the step of storing the evidence according to the evidence policy of the selected evidence generation specification.

12. The method of claim 10, comprising, in a preliminary step, authoring a plurality of the evidence generation specifications, and passing the authored plurality of evidence generation specifications to the generic evidence generation unit.

13. The method of claim 10, wherein the evidence data includes identities, objects and operations, and the method comprises comparing a format of the evidence data against the evidence template of the selected evidence generation specification to confirm that the evidence data conforms to the evidence template.

14. The method of claim 10, wherein each evidence policy includes a set of generation parameters that define whether evidence is to be generated, and the method comprises testing the received evidence data against the generation parameters to determined whether, and in what form, the one or more validation functions are to be performed to obtain the validation data.

15. The method of claim 10, wherein each evidence generation specification is associated with at least one of a plurality of specific environments, and the method comprises receiving the evidence data from one of the plurality of specific environments.

16. An apparatus for generating evidence, comprising:
a generic evidence generation core for receiving an evidence generation specification, and for receiving an evidence data;
a policy evaluator arranged to evaluate the evidence data in relation to the evidence generation specification;
a plurality of validation units each arranged to perform a generic validation function to form validation data, under control of the generic evidence generation core, such that an evidence is generated by combining the evidence data and the validation data; and
an evidence store arranged to store the generated evidence.

17. The apparatus of claim 16, further comprising an evidence generation specification unit having an authoring unit arranged to receive user commands and to produce an evidence generation specification by combining an evidence template with an evidence generation policy.

18. The apparatus of claim 17, wherein the authoring unit is arranged to produce a plurality of evidence generation specifications, each evidence generation specification comprising an evidence template that defines identities, objects and operations, and an evidence policy that specifies relationships between the identities, objects and operations of the evidence template and specifies generic validation functions to be applied to the evidence data.

19. The apparatus of claim 18, wherein the authoring unit is arranged to supply the plurality of evidence generation specifications to the generic evidence generation core.

20. An evidence generation system, comprising:
an evidence generation specification unit that includes an authoring unit arranged to form a plurality of evidence generation specifications, each evidence generation specification including an evidence template that specifies identities, objects and operations of an evidence data, and an evidence policy that specifies validation functions to be applied to the evidence data; and
a generic evidence generation unit for receiving evidence data and producing an evidence including the evidence data and validation data, wherein the generic evidence generation unit includes:
a generic evidence generation core for receiving the plurality of evidence generation specifications and for receiving the evidence data;
a policy evaluator arranged to evaluate the received evidence data in relation to the plurality of evidence generation specifications; and
a plurality of validation units each arranged to perform a generic validation function under control of the generic evidence generation core according to a selected one of the evidence generation specifications, to provide the validation data; and
an evidence store arranged to store the generated evidence.

21. The system of claim 20, wherein the generic evidence generation unit is arranged to select one amongst the plurality of evidence generation specifications by comparing a format of the received evidence data against each evidence template, and is arranged to evaluate the evidence data according to the selected one evidence generation specification.

22. The system of claim 20, wherein the plurality of validation units include a trusted time stamper, a trusted signer, a cryptographic unit, a validation period setting unit, and a version unit.

23. The system of claim 20, wherein the generic evidence generation unit is arranged to receive the evidence data from an environment-specific security application through an application program interface.

24. The system of claim 20, wherein the generic evidence generation unit is arranged to receive the evidence data from an evidence requester apparatus that performs a transaction with a customer apparatus, and the evidence data represents identities, objects and operations of the transaction.

25. The system of claim 24, wherein the customer apparatus and the evidence requester apparatus each include a trusted platform module.

26. The system of claim 20, wherein the generic evidence generation core is provided as part of the evidence requester apparatus, and the validation units are provided remote from the requester apparatus.
